(19) United States
(12) Patent Application Publication
(10) Pub. No.: US 2025/0042284 A1
(43) Pub. Date: Feb. 6, 2025

(54) METHOD FOR AGGREGATION REGULATION OPTIMIZATION OF ELECTRIC VEHICLE LOAD BY CONSIDERING COMPREHENSIVE RESPONSE COEFFICIENT

(71) Applicants: North China Electric Power University, Beijing (CN); State Grid Smart Internet of Vehicles Co., Ltd, Beijing (CN); STATE GRID SHANGHAI MUNICIPAL ELECTRIC POWER COMPANY, Shanghai (CN); STATE GRID CORPORATION OF CHINA, Beijing (CN)

(72) Inventors: Dunnan LIU, Beijing (CN); Mingguang LIU, Beijing (CN); Shengming QUAN, Beijing (CN); Wen WANG, Beijing (CN); Xingang YANG, Shanghai (CN); Shu SU, Beijing (CN); Yue ZHANG, Beijing (CN); Ye YANG, Beijing (CN); Boyuan CAO, Shanghai (CN); Weijia GUO, Beijing (CN); Peijun LI, Beijing (CN); Xiao TANG, Shanghai (CN)

(21) Appl. No.: 18/362,006

(22) Filed: Jul. 31, 2023

(51) Int. Cl. B60L 53/62; B60L 53/65; B60L 53/66

(52) U.S. Cl. CPC B60L 53/62; B60L 53/65; B60L 53/66

(57) ABSTRACT

A method for aggregation regulation optimization of an electric vehicle load by considering a comprehensive response coefficient is disclosed. The method includes the following steps: Step 1, collecting electric vehicle charging information; Step 2, based on the electric vehicle charging information collected in Step 1, calculating aggregation regulation response indexes for user participation, and determining a weight of each aggregation regulation response index; Step 3, based on the calculation result of each aggregation regulation response index for user participation obtained in Step 2, calculating a comprehensive response coefficient of an electric vehicle; and Step 4, performing the aggregation regulation optimization of the electric vehicle load by using minimum load power deviation determined by a dispatching scheme and an actually considered comprehensive response coefficient as a target and using a load rate, a peak-valley difference and a load fluctuation rate after dispatching as constraints.

### TECHNICAL FIELD

The present disclosure belongs to the technical field of charging aggregation regulation of electric vehicles, and relates to a method for aggregation regulation optimization of an electric vehicle load, particularly to a method for aggregation regulation optimization of an electric vehicle load by considering a comprehensive response coefficient.

### BACKGROUND OF THE PRESENT DISCLOSURE

Electric vehicles have been rapidly developed due to their green and environmental protection features and advantages in the aspect of dual interaction with a power grid. However, the electric vehicle load is greatly affected by user behaviors and has a significant random fluctuation feature. Large-scale access of electric vehicles in a free and unrestricted charging mode can pose threats to the safe and stable operation of the power grid, for example increasing a peak-valley difference of a power grid load and affecting the quality of electric energy supply.

Aggregating large-scale flexible resources electric vehicles and orderly charging can alleviate a series of problems caused by disordered charging. However, the traditional aggregation regulation methods still have the problems that comprehensiveness and accuracy cannot be simultaneously considered, and aggregation regulation is highly in complexity, dispatching response estimation on a user is time-consuming and labor-consuming, dimension disaster and long calculation time are prone to occur, and cannot comprehensively and objectively evaluate and quantitatively calculate users' responsiveness and perform aggregation regulation optimization according to the performance evaluation index of the aggregation scheme.

Upon retrieval, no patent documents of the existing technology which is identical or similar to the present disclosure are found.

### SUMMARY OF PRESENT DISCLOSURE

The objective of the present disclosure is to provide an method for aggregation regulation optimization of an electric vehicle load by considering a comprehensive response coefficient in order to overcome the defects in the prior art, which is able to solve the technical problems that the traditional aggregation regulation is high in complication degree and time/labor-consuming in user' dispatching response estimation, is prone to dimension disaster and has too long calculation time.

The present disclosure adopts the following technical solution to solve the practical problems:

Provided is a method for aggregation regulation optimization of an electric vehicle load by considering a comprehensive response coefficient, comprising the following steps:
Step 1, collecting electric vehicle charging information;
Step 2, calculating aggregation regulation response indexes for user participation and determining a weight of each aggregation regulation response index, according to the electric vehicle charging information collected in Step 1;
Step 3, calculating a comprehensive response coefficient of an electric vehicle and forming an initial aggregation regulation scheme, based on the calculation result of each aggregation regulation response index for user participation obtained in Step 2; and
Step 4, performing the aggregation regulation optimization of the electric vehicle load by using minimum load power deviation determined by a dispatching scheme and an actually considered comprehensive response coefficient as a target and using a load rate, a peak-valley difference and a load fluctuation rate after dispatching as constraints.

Furthermore, the electric vehicle charging information in Step 1 includes data of an electric vehicle, such as battery capacity, grid access time, grid off time, charging and discharging power, initial available capacity, dispatched capacity, participated dispatching frequency and accumulated charging cycle number.

Furthermore, the aggregation regulation response indexes for user participation in Step 2 include: user reliability, adjustable capacity ratio, battery fatigue and discharging potential, and the calculation method of the aggregation regulation response index is as follows:

(1) since the electric vehicle is completely controlled by a vehicle owner, the user reliability of the vehicle owner is necessarily measured and calculated, if an electric vehicle participating in dispatching leaves in advance in the process of participating in power grid dispatching, a connection between the electric vehicle and a power grid is forced to be interrupted, so as to affect the dispatching effect.

The user reliability can reflect the matching degree of a user on completion of dispatching within the period of time to a certain extent.

$${S}_{i} = 1 - \frac{1}{{F}_{i}} {\sum }_{f = 1}^{{F}_{i}} ( \frac{\vert {T}_{i , d}^{f} - {T}_{i , in}^{f} \vert}{{T}_{i , out}^{f} - {T}_{i , in}^{f}} ) \times 100 \%$$

In the formula, Sᵢ is the reliability of the user i, Fᵢ is the number of participating in dispatching by the user within the selected period of time. T^{f}_{i,in} and T^{f}_{i,out} are respectively the grid access time and the expected grid off time for participating in dispatching by the user i for the fth time within the period of time, and T^{f}_{i,d} is the actual grid off time for participating in dispatching by the user i for the fth time. The closer the expected grid off time of the user is to the actual grid off time, the larger the user reliability is, and when the expected grid off time is equal to the actual grid off time, the user reliability is 1.

(2) The adjustable capacity ratio is a ratio of the remaining adjustable capacity to the maximum available capacity of the electric vehicle.

$${φ}_{i} = \frac{{D}_{i , 0} - {D}_{i , 1}}{{D}_{i , 0}} \times 100 \%$$

In the formula, φᵢ is the adjustable capacity ratio of the user i, and D_{i,0} and D_{i,1} are respectively the maximum available capacity and the dispatched capacity of the user i.

(3) The battery fatigue is represented by a ratio of the accumulated charging cycle number to the maximum charging cycle number of the electric vehicle during the service life of the battery.

$${W}_{i} = \frac{{L}_{i}}{{L}_{i , 0}} \times 100 \%$$

In the formula, Wᵢ is the battery fatigue of the electric vehicle of the user i, Lᵢ and L_{i,0} are respectively the accumulated charging cycle number of the electric vehicle of the user i and the chargeable cycle number during the service life of the battery, and the larger the Wᵢ is, the higher the battery fatigue is.

(4) The discharging potential of the electric vehicle can increase the reserve capacity of the power grid, and the discharging potential of the electric vehicle is calculated according to the battery capacity, charging and discharging power, and grid access time and grid off time of the electric vehicle.

$${R}_{i} = \frac{1}{{F}_{i}} {\sum }_{f = 1}^{{F}_{i}} \frac{{P}_{i} ( {T}_{i , d}^{f} - {T}_{i , in}^{f} ) - {C}_{i} ( S O {C}_{i}^{f} - S O {C}_{i , 0}^{f} )}{{C}_{i}} \times 100 \%$$

$${SOC}_{i}^{f} = \frac{{D}_{i , 0}}{{C}_{i}}$$

In the formula, Rᵢ is the discharging potential index of the electric vehicle of the user i, Pᵢ is the discharging power of the user i, Cᵢ is the battery capacity of the user i, and SOC^{f}, and SOC^{f}_{i,0}, are respectively an initial charge state and an expected grid off charge state for participating in dispatching by the user i for the fth time.

Furthermore, the step 2 adopts an entropy weight method to calculate the weight of each aggregation regulation response index for user participation, and the calculation method of the weight of the aggregation regulation response index is as follows:

$${q}_{j} = - \frac{1}{ln N} {\sum }_{i = 1}^{N} {p}_{i j} ln {p}_{i j} , j = 1 , 2 , … , K$$

$${p}_{i j} = \frac{{I}_{i j}}{{\sum }_{i = 1}^{N} {I}_{i j}}$$

wherein, if

$${p}_{i j} = 0 , {lim}_{{p}_{ij} \to 0} {p}_{ij} ln {p}_{ij} = 0$$

is defined.

$${w}_{j} = \frac{1 - {q}_{j}}{K - {{\sum }^{K}}_{j = 1} {q}_{j}}$$

In the formula, qⱼ is an information entropy of the jth index, N is the quantity of electric vehicles, K is the quantity of aggregation reference indexes, Pᵢⱼ is the occurring probability of the jth aggregation reference index of the ith electric vehicle, Iᵢⱼ is the jth aggregation reference index of the ith electric vehicle, and wⱼ is the weight of the jth index.

Furthermore, the calculation formula for calculating the comprehensive response coefficient of the electric vehicle in Step 3 is as follows:

$${M}_{i} = {{\sum }^{K}}_{j = 1} {w}_{j} {d}_{i j}$$

for the ith electric vehicle, if Mᵢ≤η, the electric vehicle is incorporated in the consideration range of participating in dispatching, or else, the electric vehicle is not incorporated; Mᵢ is the comprehensive response coefficient of the ith electric vehicle, dᵢⱼ is the numeral value of each aggregation regulation response index of the ith electric vehicle, j, from 1 to 4, respectively represents user reliability, adjustable capacity ratio, battery fatigue and discharging potential, and η is a threshold of the comprehensive response coefficient.

Furthermore, the Step 4 specifically comprises:
establishing an objective function:

$$min F = min {\sum }_{t = 1}^{H} \vert {P}_{0 , t} - {\sum }_{n = 1}^{{N}_{K}} {λ}_{n} {P}_{n , t} \vert$$

In the formula, P_{0,t} is the power of the project t period issued by a dispatching mechanism, P_{n,1} is the power of the user n in time t in actual dispatching, N_{K} is the quantity of electric vehicle users in actual dispatching, λₙ is a 0-1 corrected coefficient of the user n, 1 represents participating in dispatching, 0 represents not participating in dispatching, and H is the number of the periods for participating in dispatching.

Constraint conditions:

$$X = \frac{\frac{1}{H} {\sum }_{t = 1}^{H} {\sum }_{n = 1}^{{N}_{K}} {λ}_{n} {P}_{n , t}}{{max}_{t} {{\sum }^{{N}_{K}}}_{n = 1} {λ}_{n} {P}_{n , t}} \leq {θ}_{1}$$

$$Y = {max}_{t} {\sum }_{n = 1}^{{N}_{K}} {λ}_{n} {P}_{n , t} - {min}_{t} {\sum }_{n = 1}^{{N}_{K}} {λ}_{n} {P}_{n , t} \leq {θ}_{2}$$

$$Z = \frac{\sqrt{\frac{1}{H} {\sum }_{t = 1}^{H} {( {\sum }_{n = 1}^{{N}_{K}} {λ}_{n} {P}_{n , t} - \frac{1}{H} {\sum }_{t = 1}^{H} {\sum }_{n = 1}^{{N}_{K}} {λ}_{n} {P}_{n , t} )}^{2}}}{\frac{1}{H} {\sum }_{t = 1}^{H} {\sum }_{n = 1}^{{N}_{K}} {λ}_{n} {P}_{n , t}} \leq {θ}_{3}$$

In the formula, X represents a load rate which is a ratio of an average load to a maximum load, Y represents a peak-valley difference which is a difference between a maximum load and a minimum load, Z represents a load fluctuation rate which is a ratio of standard load deviation to an average load, and θ₁, θ₂ and θ₃ are respectively a load rate, a peak-valley difference and a load fluctuation rate threshold after dispatching.

The present disclosure has the advantages and beneficial effects:

1. The present disclosure provides an method for aggregation regulation optimization of an electric vehicle load by considering a comprehensive response coefficient, a comprehensive response coefficient calculation model of an electric vehicle is established based on the collected data information, the method for optimizing aggregation regulation of the load of the electric vehicle is determined by comprehensively considering many factors such as the user reliability, adjustable capacity ratio and battery fatigue and analyzing the negative load, peak-valley difference and load fluctuation rate indexes of the electric vehicle after being dispatched.

2. The weight of each aggregation reference index of the electric vehicle user is determined by using the entropy weight method, which can reflect the distinguishing ability of different indexes such as user reliability, adjustable capacity ratio, battery fatigue and discharging potential, has a certain reliability and accuracy compared with a subjective weight, and is easy to operate the calculation process.

3. The load rate, peak-valley difference and load fluctuation rate threshold of the aggregation regulation of the electric vehicle load are set to restrict the load subjected to aggregation regulation from many aspects, thereby reducing the security threat of the large-scale electric vehicle load access on an electric power system, and facilitating the safe and stable operation of the electric power system.

### DESCRIPTION OF THE DRAWINGS

FIG. 1 is a flowchart of a method for aggregation regulation optimization of an electric vehicle load by considering a comprehensive response coefficient according to the present disclosure;

FIG. 2 is graph showing comparison between an aggregation load curve and a dispatching scheme before and after optimization according to the disclosure.

### DETAILED DESCRIPTION OF PREFERRED EMBODIMENTS

The embodiments of the present disclosure will be further described in detail in combination with drawings.

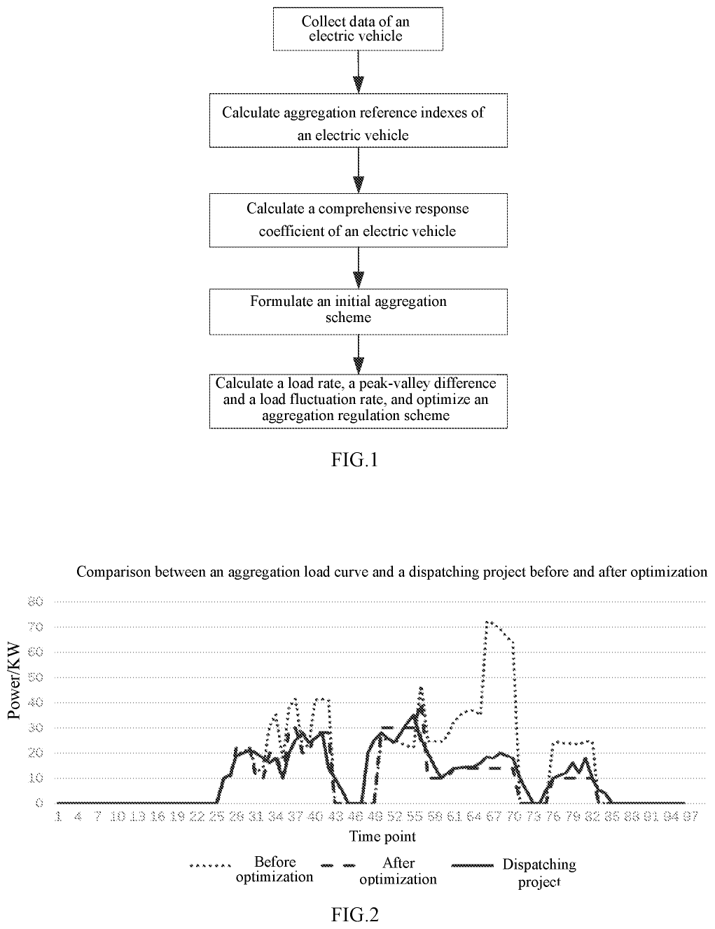

Provided is a method for aggregation regulation optimization of an electric vehicle load by considering a comprehensive response coefficient, as shown in FIG. 1, comprising the following steps:

Step 1, collecting electric vehicle charging information;

The electric vehicle charging information in Step 1 includes data of an electric vehicle, such as battery capacity, grid access time, grid off time, charging and discharging power, initial available capacity, dispatched capacity, participated dispatching frequency and accumulated charge cycle number.

Step 2, calculating aggregation regulation response indexes for user participation and determining a weight of each aggregation regulation response index, according to the electric vehicle charging information collected in Step 1.

The aggregation regulation response indexes for user participation in Step 2 include: user reliability, adjustable capacity ratio, battery fatigue and discharging potential, and the calculation method of the aggregation regulation response index is as follows:

(1) since the electric vehicle is completely controlled by a vehicle owner, the user reliability of the vehicle owner is necessarily measured and calculated, if an electric vehicle participating in dispatching leaves in advance in the process of participating in power grid dispatching, a connection between the electric vehicle and a power grid is forced to be interrupted, so as to affect the dispatching effect.

The user reliability can reflect the matching degree of a user on completion of dispatching within the period of time to a certain extent.

$${S}_{i} = 1 - \frac{1}{{F}_{i}} {\sum }_{f = 1}^{{F}_{i}} ( \frac{\vert {T}_{i , d}^{f} - {T}_{i , i n}^{f} \vert}{{T}_{i , o u t}^{f} - {T}_{i , i n}^{f}} ) \times 100 \%$$

In the formula, Sᵢ is the reliability of the user i, Fᵢ is the number of participating in dispatching by the user within the selected period of time. T^{f}_{i,in} and T^{f}_{i,out} are respectively the grid access time and the expected grid off time for participating in dispatching by the user i for the fth time within the period of time, and T^{f}_{i,d} is the actual grid off time for participating in dispatching by the user i for the fth time. The closer the expected grid off time of the user is to the actual grid off time, the larger the user reliability is, and when the expected grid off time is equal to the actual grid off time, the user reliability is 1.

(2) The adjustable capacity ratio is a ratio of the remaining adjustable capacity to the maximum available capacity of the electric vehicle.

$${φ}_{i} = \frac{{D}_{i , 0} - {D}_{i , 1}}{{D}_{i , 0}} \times 100 \%$$

In the formula, φᵢ is the adjustable capacity ratio of the user i, and D_{i,0} and D_{i,1} are respectively the maximum available capacity and the dispatched capacity of the user i.

(3) The battery fatigue is represented by a ratio of the accumulated charging cycle number to the maximum charging cycle number of the electric vehicle during the service life of the battery.

$${W}_{i} = \frac{{L}_{i}}{{L}_{i , 0}} \times 100 \%$$

In the formula, Wᵢ is the battery fatigue of the electric vehicle of the user i, Lᵢ and L_{i,0} are respectively the accumulated charging cycle number of the electric vehicle of the user i and the chargeable cycle number during the service life of the battery, and the larger the Wᵢ is, the higher the battery fatigue is.

(4) The discharging potential of the electric vehicle can increase the reserve capacity of the power grid, and the discharging potential of the electric vehicle is calculated according to the battery capacity, charging and discharging power, and grid access time and grid off time of the electric vehicle.

$${R}_{i} = \frac{1}{{F}_{i}} {\sum }_{f = 1}^{{F}_{i}} \frac{{P}_{i} ( {T}_{i , d}^{f} - {T}_{i , in}^{f} ) - {C}_{i} ( S O {C}_{i}^{f} - S O {C}_{i , 0}^{f} )}{{C}_{i}} \times 100 \%$$

$${SOC}_{i}^{f} = \frac{{D}_{i , 0}}{{C}_{i}}$$

In the formula, Rᵢ is the discharging potential index of the electric vehicle of the user i, Pᵢ is the discharging power of the user i, Cᵢ is the battery capacity of the user i, and SOC^{f}ᵢ and SOC^{f}_{i,0} are respectively an initial charge state and an expected grid off charge state for participating in dispatching by the user i for the fth time.

The step 2 adopts an entropy weight method to calculate the weight of each aggregation regulation response index for user participation, and the calculation method of the weight of the aggregation regulation response index is as follows:

$${q}_{j} = - \frac{1}{ln N} {\sum }_{i = 1}^{N} {p}_{i j} ln {p}_{i j} , j = 1 , 2 , … , K$$

$${p}_{i j} = \frac{{I}_{i j}}{{\sum }_{i = 1}^{N} {I}_{i j}}$$

wherein, if

$${p}_{i j} = 0 , \\ {lim}_{{p}_{ij} \to 0} {p}_{ij} ln {p}_{ij} = 0$$

is defined.

$${w}_{j} = \frac{1 - {q}_{j}}{K - {\sum }_{j = 1}^{K} {q}_{j}}$$

In the formula, qⱼ is information entropy of the jth index, N is the quantity of electric vehicles, K is the quantity of aggregation reference indexes, pᵢⱼ is the occurring probability of the jth aggregation reference index of the ith electric vehicle, Iᵢⱼ is the jth aggregation reference index of the ith electric vehicle, and wⱼ is the weight of the jth index.

Step 3, calculating a comprehensive response coefficient of an electric vehicle based on the calculation result of each aggregation regulation response index for user participation obtained in Step 2 and performing preferred dispatching on the user of the electric vehicle with a comprehensive response coefficient being more than a set threshold based on the dispatching project issued by a power grid dispatching mechanism, wherein the user of the electric vehicle with a comprehensive response coefficient being less than the set threshold is not incorporated within the dispatching range, and therefore an initial aggregation regulation scheme is formed;

the calculation formula for calculating the comprehensive response coefficient of the electric vehicle in Step 3 is as follows:

$${M}_{i} = {\sum }_{j = 1}^{K} {w}_{j} {d}_{i j}$$

for the ith electric vehicle, if Mᵢ≥η, the electric vehicle is incorporated in the consideration range of participating in dispatching, or else, the electric vehicle is not incorporated; Mᵢ is the comprehensive response coefficient of the ith electric vehicle, dᵢⱼ is the numeral value of each aggregation regulation response index of the ith electric vehicle, j, from 1 to 4, respectively represents user reliability, adjustable capacity ratio, battery fatigue and discharging potential, and η is a threshold of the comprehensive response coefficient.

Step 4, performing the aggregation regulation optimization of the electric vehicle load by using minimum load power deviation determined by a dispatching scheme and an actually considered comprehensive response coefficient as a target and using a load rate, a peak-valley difference and a load fluctuation rate after dispatching as constraints.

The Step 4 specifically comprises:
establishing an objective function:

$$min F = min {\sum }_{t = 1}^{H} \vert {P}_{0 , t} - {\sum }_{n = 1}^{{N}_{K}} {λ}_{n} {P}_{n , t} \vert$$

In the formula, P_{0,t} is the power of the project t period issued by a dispatching mechanism, P_{n,1} is the power of the user n in time t in actual dispatching, N_{K} is the quantity of electric vehicle users in actual dispatching, λₙ is a 0-1 corrected coefficient of the user n, 1 represents participating in dispatching, 0 represents not participating in dispatching, and H is the number of the periods for participating in dispatching.

Constraint conditions:

$$X = \frac{\frac{1}{H} {\sum }_{t = 1}^{H} {\sum }_{n = 1}^{{N}_{K}} {λ}_{n} {P}_{n , t}}{{max}_{t} {\sum }_{n = 1}^{{N}_{K}} {λ}_{n} {P}_{n , t}} \leq {θ}_{1} \\ Y = {max}_{t} {\sum }_{n = 1}^{{N}_{K}} {λ}_{n} {P}_{n , t} - {min}_{t} {\sum }_{n = 1}^{{N}_{K}} {λ}_{n} {P}_{n , t} \leq {θ}_{2} \\ Z = \frac{\sqrt{\frac{1}{H} {\sum }_{t = 1}^{H} {( {\sum }_{n = 1}^{{N}_{K}} {λ}_{n} {P}_{n , t} - \frac{1}{H} {\sum }_{t = 1}^{H} {\sum }_{n = 1}^{{N}_{k}} {λ}_{n} {P}_{n , t} )}^{2}}}{\frac{1}{H} {\sum }_{t = 1}^{H} {\sum }_{n = 1}^{{N}_{K}} {λ}_{n} {P}_{n , t}} \leq {θ}_{3}$$

In the formula, X represents a load rate which is a ratio of an average load to a maximum load, Y represents a peak-valley difference which is a difference between a maximum load and a minimum load, Z represents a load fluctuation rate which is a ratio of standard load deviation to an average load, and θ₁, θ₂ and θ₃ are respectively a load rate, a peak-valley difference and a load fluctuation rate threshold after dispatching, the value ranges of θ₁ and θ₃ are generally (20%, 50%) and (10%, 30%), and the value of θ₂ is generally no more than a maximum load of a charging station.

Next, the present disclosure will be further described in combination with specific calculation embodiments.

By taking the dispatching of the electric vehicle at a district as an example, the battery capacity, grid access time, expected grid off time, actual grid off time, charging and discharging power and other data were collected, the charging and discharging power of the same electric vehicle participating in the dispatching at this moment was set to be consistent and equal, and the expected grid off charge states of the users were 100%. Specific data are seen in Table 1.

TABLE 1
Data collection information of electric vehicles

| | | | | Actual | | Maximum | | | | Chargeable |
|---|---|---|---|---|---|---|---|---|---|---|
| | Battery | Grid | Expected | grid | Charging | available | Dispatched | Participated | Accumulated | cycle number |
| Electric | capacity/ | access | grid off | off | power/ | capacity/ | capacity/ | dispatching | charge cycle | within |
| vehicle | kWh | time | time | time | KW | kWh | kWh | frequency | number | services life |
| EV1 | 100 | 6:30 | 8:00 | 8:20 | 10 | 20 | 5 | 10 | 1000 | 2000 |
| EV2 | 130 | 7:00 | 8:00 | 8:00 | 12 | 10 | 8 | 20 | 750 | 1500 |
| EV3 | 200 | 8:25 | 9:25 | 9:15 | 10 | 20 | 10 | 15 | 700 | 1400 |
| EV4 | 105 | 9:00 | 10:00 | 10:20 | 20 | 20 | 10 | 40 | 1200 | 1600 |
| EV5 | 100 | 10:00 | 10:30 | 10:30 | 8 | 50 | 20 | 30 | 500 | 1500 |
| EV6 | 40 | 12:40 | 15:00 | 14:00 | 30 | 10 | 5 | 25 | 500 | 2000 |
| EV7 | 100 | 14:10 | 15:00 | 15:00 | 10 | 30 | 10 | 5 | 250 | 2000 |
| EV8 | 84 | 15:25 | 17:25 | 17:25 | 14 | 30 | 10 | 40 | 800 | 1600 |
| EV9 | 80 | 16:40 | 18:30 | 17:30 | 10 | 10 | 8 | 20 | 300 | 1200 |
| EV10 | 90 | 19:00 | 21:00 | 20:30 | 10 | 20 | 12 | 10 | 1200 | 1600 |

The user reliability, adjustable capacity ratio, battery fatigue and discharging potential indexes of each electric vehicle obtained by calculation are seen in Table 2.

TABLE 2
Aggregation reference indexes of vehicles

| Electric | User | Adjustable | Battery | Discharging |
|---|---|---|---|---|
| vehicle | reliability/% | capacity/% | fatigue/% | potential/% |
| EV1 | 22.22 | 75.00 | 50.00 | 98.33 |
| EV2 | 100.00 | 20.00 | 50.00 | 85.60 |
| EV3 | 16.67 | 50.00 | 50.00 | 82.13 |
| EV4 | 33.33 | 50.00 | 75.00 | 90.42 |
| EV5 | 100.00 | 60.00 | 33.33 | 52.00 |
| EV6 | 42.86 | 50.00 | 25.00 | 78.40 |
| EV7 | 100.00 | 66.68 | 12.50 | 78.33 |
| EV8 | 100.00 | 66.68 | 50.00 | 90.50 |
| EV9 | 54.55 | 20.00 | 25.00 | 81.93 |
| EV10 | 25.00 | 40.00 | 75.00 | 96.00 |

The weights of four indexes are determined by an entropy weight method, which are 6.72%, 30.90%, 31.51% and 30.87% respectively.

The comprehensive response coefficients of electric vehicles obtained by calculation are shown in Table 3.

TABLE 3
Comprehensive response coefficients of electric vehicles

| Electric | Comprehensive response |
|---|---|
| vehicles | coefficients |
| EV1 | 30.76 |
| EV2 | 26.71 |
| EV3 | 25.68 |
| EV4 | 28.33 |
| EV5 | 16.41 |
| EV6 | 24.47 |
| EV7 | 24.50 |
| EV8 | 28.37 |
| EV9 | 25.27 |
| EV10 | 30.01 |

Three aggregation regulation schemes are set to compare the load rates, peak-valley differences and load fluctuation rates of different schemes.

EV1-EV10 full-aggregation was used as scheme I;

The threshold of the comprehensive response coefficient was selected as 25, EV1, EV2, EV3, EV4, EV8, EV9 and EV10 were dispatched as scheme II;

An absolute value of a difference between dispatching scheme power and actual dispatching power was used as an objective function. Based on experience, the load rate, peak-valley difference and load fluctuation rate threshold were respectively set as 35%, 30 kW and 15%. According to calculation, EV1, EV2, EV3, EV4, EV8, EV9 and EV10 were dispatched as scheme III;

The comparison results of three schemes are shown in Table 4, and comparison between an aggregation load curve and a dispatching scheme before and after optimization is shown in FIG. 2. It can be seen from the figure that during time points 33-43, 56-71 and 76-82, the aggregation loads of the electric vehicle before optimization are all more than those of the dispatching scheme, the loads before optimization during time points 56-71 are 53 kW more than the loads of the dispatching scheme, and the load after optimization at each time point is closer to that of the dispatching scheme, thereby achieving the effect of reducing total peak-valley difference and fluctuation rate.

TABLE 4
Comparison of different aggregation regulation schemes

| | | | Load |
|---|---|---|---|
| | Load | Peak-valley | fluctuation |
| Schemes | rate | difference | rate |
| Scheme I | 37.72% | 40 kw | 9.19% |
| Scheme II | 33.68% | 30 kw | 8.29% |
| Scheme III | 30.76% | 30 kw | 7.78% |

It is emphasized that the embodiments of the present disclosure are illustrative but not limiting, and therefore the present disclosure includes but is not limited to examples described in specific embodiments, and other embodiments obtained by those skilled in the art according to the technical solution of the present application are similarly included within the protective scope of the present disclosure.

We claim:

1. A method for aggregation regulation optimization of an electric vehicle load by considering a comprehensive response coefficient, comprising the following steps:
Step 1, collecting electric vehicle charging information;
Step 2, calculating aggregation regulation response indexes for user participation and determining a weight of each aggregation regulation response index, according to the electric vehicle charging information collected in Step 1;
Step 3, calculating a comprehensive response coefficient of an electric vehicle and forming an initial aggregation regulation scheme, based on the calculation result of each aggregation regulation response index for user participation obtained in Step 2; and
Step 4, performing the aggregation regulation optimization of the electric vehicle load by using minimum load power deviation determined by a dispatching scheme and an actually considered comprehensive response coefficient as a target and using a load rate, a peak-valley difference and a load fluctuation rate after dispatching as constraints.

2. The method for aggregation regulation optimization of an electric vehicle load by considering a comprehensive response coefficient according to claim 1, wherein the electric vehicle charging information in Step 1 includes data of an electric vehicle, such as battery capacity, grid access time, grid off time, charging and discharging power, initial available capacity, dispatched capacity, participated dispatching frequency and accumulated charging cycle number.

3. The method for aggregation regulation optimization of an electric vehicle load by considering a comprehensive response coefficient according to claim 1, wherein the aggregation regulation response indexes for user participation in Step 2 include: user reliability, adjustable capacity ratio, battery fatigue and discharging potential, and the calculation method of the aggregation regulation response index is as follows:
(1) since the electric vehicle is completely controlled by a vehicle owner, the user reliability of the vehicle owner is necessarily measured and calculated, if an electric vehicle participating in dispatching leaves in advance in the process of participating in power grid dispatching, a connection between the electric vehicle and a power grid is forced to be interrupted, so as to affect the dispatching effect.
The user reliability can reflect the matching degree of a user on completion of dispatching within the period of time to a certain extent.
$${S}_{i} = 1 - \frac{1}{{F}_{i}} {\sum }_{f = 1}^{{F}_{i}} ( \frac{\vert {T}_{i , d}^{f} - {T}_{i , in}^{f} \vert}{{T}_{i , out}^{f} - {T}_{i , in}^{f}} ) \times 100 \%$$
In the formula, Sᵢ is the reliability of the user i, Fᵢ is the number of participating in dispatching by the user within the selected period of time. T^{f}_{i,in} and T^{f}_{i,out} are respectively the grid access time and the expected grid off time for participating in dispatching by the user i for the fth time within the period of time, and T^{f}_{i,d} is the actual grid off time for participating in dispatching by the user i for the fth time. The closer the expected grid off time of the user is to the actual grid off time, the larger the user reliability is, and when the expected grid off time is equal to the actual grid off time, the user reliability is 1.
(2) The adjustable capacity ratio is a ratio of the remaining adjustable capacity to the maximum available capacity of the electric vehicle.
$${φ}_{i} = \frac{{D}_{i , 0} - {D}_{i , 1}}{{D}_{i , 0}} \times 100 \%$$
In the formula, φᵢ is the adjustable capacity ratio of the user i, and D_{i,0} and D_{i,1} are respectively the maximum available capacity and the dispatched capacity of the user i.
(3) The battery fatigue is represented by a ratio of the accumulated charging cycle number to the maximum charging cycle number of the electric vehicle during the service life of the battery.
$${W}_{i} = \frac{{L}_{i}}{{L}_{i , 0}} \times 100 \%$$
In the formula, Wᵢ is the battery fatigue of the electric vehicle of the user i, Lᵢ and L_{i,0} are respectively the accumulated charging cycle number of the electric vehicle of the user i and the chargeable cycle number during the service life of the battery, and the larger the Wᵢ is, the higher the battery fatigue is.
(4) The discharging potential of the electric vehicle can increase the reserve capacity of the power grid, and the discharging potential of the electric vehicle is calculated according to the battery capacity, charging and discharging power, and grid access time and grid off time of the electric vehicle.
$${R}_{i} = \frac{1}{{F}_{i}} {\sum }_{f = 1}^{{F}_{i}} \frac{{P}_{i} ( {T}_{i , d}^{f} - {T}_{i , in}^{f} ) - {C}_{i} ( {SOC}_{i}^{f} - {SOC}_{i , 0}^{f} )}{{C}_{i}} \times 100 \% \\ {SOC}_{i}^{f} = \frac{{D}_{i , 0}}{{C}_{i}}$$
In the formula, Rᵢ is the discharging potential index of the electric vehicle of the user i, Pᵢ is the discharging power of the user i, Cᵢ is the battery capacity of the user i, and SOC^{f}ᵢ and SOC^{f}_{i,0} are respectively an initial charge state and an expected grid off charge state for participating in dispatching by the user i for the fth time.

4. The method for aggregation regulation optimization of an electric vehicle load by considering a comprehensive response coefficient according to claim 1, wherein the step 2 adopts an entropy weight method to calculate the weight of each aggregation regulation response index for user participation, and the calculation method of the weight of the aggregation regulation response index is as follows:
$${q}_{j} = - \frac{1}{ln N} {\sum }_{i = 1}^{N} {p}_{i j} ln {p}_{i j} , j = 1 , 2 , … , K \\ {p}_{i j} = \frac{{I}_{i j}}{{{\sum }_{i = 1}}^{N} {I}_{i j}}$$
wherein, if
$${p}_{i j} = 0 , \\ {lim}_{{p}_{ij} \to 0} {p}_{ij} ln {p}_{ij} = 0$$
is defined.
$${w}_{j} = \frac{1 - {q}_{j}}{K - {{\sum }_{j = 1}}^{K} {q}_{j}}$$
In the formula, qⱼ is an information entropy of the jth index, N is the quantity of electric vehicles, K is the quantity of aggregation reference indexes, pᵢⱼ is the occurring probability of the jth aggregation reference index of the ith electric vehicle, Iᵢⱼ is the jth aggregation reference index of the ith electric vehicle, and wⱼ is the weight of the jth index.

5. The method for aggregation regulation optimization of an electric vehicle load by considering a comprehensive response coefficient according to claim 1, wherein the calculation formula for calculating the comprehensive response coefficient of the electric vehicle in Step 3 is as follows:
$${M}_{i} = {\sum }_{j = 1}^{K} {w}_{j} {d}_{ij}$$
for the ith electric vehicle, if Mᵢ≥η, the electric vehicle is incorporated in the consideration range of participating in dispatching, or else, the electric vehicle is not incorporated; Mᵢ is the comprehensive response coefficient of the ith electric vehicle, dᵢⱼ is the numeral value of each aggregation regulation response index of the ith electric vehicle, j, from 1 to 4, respectively represents user reliability, adjustable capacity ratio, battery fatigue and discharging potential, and η is a threshold of the comprehensive response coefficient.

6. The method for aggregation regulation optimization of an electric vehicle load by considering a comprehensive response coefficient according to claim 1, wherein the Step 4 specifically comprises:
establishing an objective function:
$$min F = min {\sum }_{t = 1}^{H} \vert {P}_{0 , t} - {\sum }_{n = 1}^{{N}_{K}} {λ}_{n} {P}_{n , t} \vert$$
In the formula, P_{0,t} is the power of the project t period issued by a dispatching mechanism, P_{n,1} is the power of the user n in time t in actual dispatching, N_{K} is the quantity of electric vehicle users in actual dispatching, λₙ is a 0-1 corrected coefficient of the user n, 1 represents participating in dispatching, 0 represents not participating in dispatching, and H is the number of the periods for participating in dispatching.
Constraint conditions:
$$X = \frac{\frac{1}{H} {\sum }_{t = 1}^{H} {\sum }_{n = 1}^{{N}_{K}} {λ}_{n} {P}_{n , t}}{{max}_{t} {\sum }_{n = 1}^{{N}_{K}} {λ}_{n} {P}_{n , t}} \leq {θ}_{1} \\ Y = {max}_{t} {\sum }_{n = 1}^{{N}_{K}} {λ}_{n} {P}_{n , t} - {min}_{t} {\sum }_{n = 1}^{{N}_{K}} {λ}_{n} {P}_{n , t} \leq {θ}_{2} \\ Z = \frac{\sqrt{\frac{1}{H} {\sum }_{t = 1}^{H} {( {\sum }_{n = 1}^{{N}_{K}} {λ}_{n} {P}_{n , t} - \frac{1}{H} {\sum }_{t = 1}^{H} {\sum }_{n = 1}^{{N}_{k}} {λ}_{n} {P}_{n , t} )}^{2}}}{\frac{1}{H} {\sum }_{t = 1}^{H} {\sum }_{n = 1}^{{N}_{K}} {λ}_{n} {P}_{n , t}} \leq {θ}_{3}$$
In the formula, X represents a load rate which is a ratio of an average load to a maximum load, Y represents a peak-valley difference which is a difference between a maximum load and a minimum load, Z represents a load fluctuation rate which is a ratio of standard load deviation to an average load, and θ₁, θ₂ and θ₃ are respectively a load rate, a peak-valley difference and a load fluctuation rate threshold after dispatching.
